(19) United States
(12) Patent Application Publication
(10) Pub. No.: US 2023/0394630 A1
(43) Pub. Date: Dec. 7, 2023

(54) METHOD AND SYSTEM FOR TRAINING AND TUNING NEURAL NETWORK MODELS FOR DENOISING

(71) Applicant: KONINKLIJKE PHILIPS N.V., EINDHOVEN (NL)

(72) Inventors: FRANK BERGNER, HAMBURG (DE); CHRISTIAN WUELKER, HAMBURG (DE); NIKOLAS DAVID SCHNELLBAECHER, MAINZ (DE); THOMAS KOEHLER, HAMBURG (DE); KEVIN MARTIN BROWN, HIGHLAND HEIGHTS, OH (US)

(21) Appl. No.: 18/032,357

(22) PCT Filed: Oct. 14, 2021
(86) PCT No.: PCT/EP2021/078507

§ 371 Date: Apr. 18, 2023

Related U.S. Application Data
(60) Provisional application No. 63/104,382, filed on Oct. 22, 2020.

(51) Int. Cl. G06T 5/00; G06T 7/00

(52) U.S. Cl. CPC G06T 5/002; G06T 7/0002; G06T 2207/20081; G06T 2207/20084; G06T 2207/30168; G06T 2207/10081; G06T 2207/30004

(57) ABSTRACT

One embodiment of the present disclosure may provide a method for training and tuning a neural network model, including: adding simulated noise to an initial image of an object to generate a noisy image (601, 603), the simulated noise taking the same form as natural noise in the initial image; training a neural network model on the noisy image using the initial image as ground truth (605), wherein in the neural network model is trained on the noisy work model a tuning variable is extracted or generated, the tuning variable defining an amount of noise removed during use (607); identifying a first value for the tuning variable that minimizes a training cost function for the tuning variable is identified or for the initial image; and assigning a second value for the tuning variable (611), the second value different than the first value, wherein the neural network model identifies more noise in the noisy image when using the second value than when using the first value.

### FIELD

The present disclosure generally relates to systems and methods for training and tuning neural network models for denoising images and for denoising images using a trained neural network.

### BACKGROUND

Conventionally, in most imaging modalities there are effects in the acquisition physics or reconstruction that lead to specific artifacts, such as noise, in the final image. In order to train a denoising neural network model in a supervised fashion, pairs of noisy and noiseless image samples are presented to the neural network model and the network attempts to minimize a cost function by denoising the noisy image to recover a corresponding noiseless ground truth image. This may be by predicting a noise image that, when subtracted from the noisy image, yields or approximates the noiseless image.

However, in the context of CT scans, sample “noiseless” images used as ground truth are not truly noiseless, and are already sub-optimal because a clinically applied dose of radiation is limited. This creates a baseline of noise for “noiseless” images that can be used for training. Further, even when high dose radiation can be applied, as in the case of cadaver scans, noise is still introduced by the mechanics of the imaging tools, such as a scanner for the machinery may be limited in tube current.

Some existing approaches are to reconstruct ground truth samples with high-quality iterative reconstruction. However, these approaches in developing simulated clean images may introduce other image artifacts, which may then be introduced into any image denoised using an AI network trained with such images as ground truth. As such, AI networks may not learn to detect real underlying anatomy.

There is a need for a method for training AI neural networks models with sub-optimal noisy ground truth image, such that the network can still generate noise free images. There is a further need for a method for denoising images that can generate image quality better than ground truth images on which it was trained.

The description provided in the background section should not be assumed to be prior art merely because it is mentioned in or associated with the background section. The background section may include information that describes one or more aspects of the subject technology.

### SUMMARY

A method is provided for training a neural network model in which initial images containing natural noise are used to train the network. In such a method, simulated noise is added to the initial images, and in some embodiments, the simulated noise added takes the same form as the natural noise in the corresponding image. The neural network model is then trained to remove noise taking the form of the natural noise while applying a scaling factor.

The network model is then optimized by identifying a first value of the scaling factor, which minimizes a cost function for the network by minimizing differences between the output of the neural network model and the initial images. After optimizing, the scaling factor is modified, such that more noise is removed than necessary to reconstruct the ground truth images.

One embodiment of the present disclosure may provide a method for training and tuning a neural network model. The method may include providing an initial image of an object, the initial image containing natural noise. The method may further include adding simulated noise to the initial image of the object to generate a noisy image, the simulated noise taking the same form as the natural noise in the initial image. The method may further include training a neural network model on the noisy image using the initial image as ground truth. In the neural network model a tuning variable is extracted or generated, the tuning variable defining an amount of noise removed during use. The method may further include identifying a first value for the tuning variable that minimizes a training cost function for the initial image. The method may further include assigning a second value for the tuning variable, the second value different than the first value. The neural network model identifies more noise in the noisy image when using the second value than when using the first value.

Another embodiment of the present disclosure may provide a neural network training and tuning system. The system may include: a memory that stores a plurality of instructions; and processor circuitry that couples to the memory. The processor circuitry is configured to execute the instructions to: provide an initial image of an object, the initial image containing natural noise; add simulated noise to the initial image of the object to generate a noisy image, the simulated noise taking the same form as the natural noise in the initial image; train a neural network model on the noisy image using the initial image as ground truth, wherein in the neural network model a tuning variable is extracted or generated, the tuning variable defining an amount of noise removed during use; identify a first value for the tuning variable that minimizes a training cost function for the initial image; and assign a second value for the tuning variable, the second value being different than the first value, wherein the neural network model identifies more noise in the noisy image when using the second value than when using the first value.

### BRIEF DESCRIPTION OF THE DRAWINGS

FIG. 1 is a schematic diagram of a system according to one embodiment of the present disclosure.

FIG. 2 illustrates an imaging device according to one embodiment of the present disclosure.

FIG. 3 is a schematic diagram of a processing device according to one embodiment of the present disclosure.

FIGS. 4A-4B illustrate schematic examples of initial images and noisy images according to one embodiment of the present disclosure.

FIGS. 5A-5C illustrate example results for denoising according to one embodiment of the present disclosure.

FIGS. 6 and 7 illustrate flowcharts of methods according to embodiments of the present disclosure.

### DETAILED DESCRIPTION OF THE PREFERRED EMBODIMENTS

The description of illustrative embodiments according to principles of the present disclosure is intended to be read in connection with the accompanying drawings, which are to be considered part of the entire written description. In the description of embodiments of the disclosure disclosed herein, any reference to direction or orientation is merely intended for convenience of description and is not intended in any way to limit the scope of the present disclosure. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the disclosure are illustrated by reference to the exemplified embodiments. Accordingly, the disclosure expressly should not be limited to such exemplary embodiments illustrating some possible non-limiting combination of features that may exist alone or in other combinations of features; the scope of the disclosure being defined by the claims appended hereto.

This disclosure describes the best mode or modes of practicing the disclosure as presently contemplated. This description is not intended to be understood in a limiting sense, but provides an example of the disclosure presented solely for illustrative purposes by reference to the accompanying drawings to advise one of ordinary skill in the art of the advantages and construction of the disclosure. In the various views of the drawings, like reference characters designate like or similar parts.

It is important to note that the embodiments disclosed are only examples of the many advantageous uses of the innovative teachings herein. In general, statements made in the specification of the present application do not necessarily limit any of the various claimed disclosures. Moreover, some statements may apply to some inventive features but not to others. In general, unless otherwise indicated, singular elements may be in plural and vice versa with no loss of generality.

In order to train a denoising neural network model in a supervised fashion, pairs of noisy and noiseless image samples are presented to the network model and penalize the misprediction of the noise during training by way of a cost function. Noisy images are generated from the noiseless image samples by simulating noise using noise generation tools. In one example, for computerized tomography (CT), clinically evaluated noise generation tools allow a system to create highly realistic noise for existing clinical ground truth noiseless images forming a raw data set.

However, the clinical ground truth images are not truly noiseless. As such, they may already be sub-optimal because a clinically applied radiation dose is limited in accordance with an “ALARA” (as-low-as-reasonably-achievable) principle by a radiologist. This creates a baseline of noise in the ground truth images, such that truly noiseless images, which would be desired for training, cannot be achieved.

The present disclosure teaches methods which may train networks with sub-optimal, noisy ground truth image, and still get noise-free, or nearly noise-free images, by overcorrecting the images using the network predictions. In this way the present disclosure helps to overcome the problem of lacking noise-free ground truth image in the domain of medical image denoising.

The present disclosure may use a residual-learning approach, which means that the denoising network is trained to predict the noise in the input image, which is then subtracted to yield the denoised image. This may be different from direct denoising, where the network is trained to directly predict the denoised image from the input. However, the systems and methods described herein may be applied in either context.

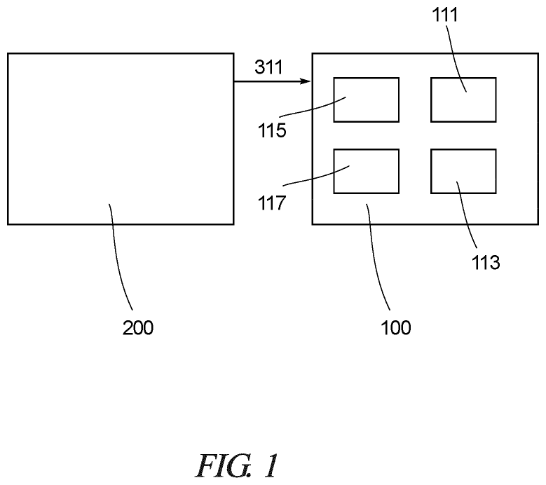

As shown in FIG. 1, a system according to one embodiment of the present disclosure may include a processing device 100 and an imaging device 200.

The processing device 100 may train a neural network model to denoise an image. The processing device 100 may include a memory 113 and processor circuitry 111. The memory 113 may store a plurality of instructions. The processor circuitry 111 may couple to the memory 113 and may be configured to execute the instructions. The processing device 100 may further include an input 115 and an output 117. The input 115 may receive information, such as an initial image 311, from the imaging device 200. The output 117 may output information to the user. The output may include a monitor or display.

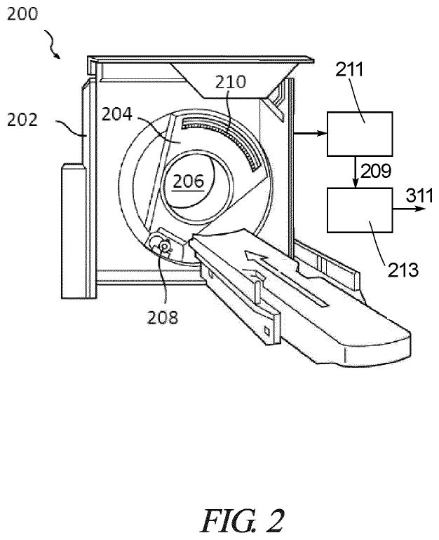

In some embodiments, the processing device 100 may relate to the imaging device 200. In some embodiments, the imaging device 200 may include an image data processing device, and a spectral CT scanning unit for generating the CT projection data when scanning an object (e.g., a patient). For example, FIG. 2 illustrates an exemplary imaging device 200 in accordance with embodiments of the present disclosure. While a CT imaging device is shown, and the following discussion is in the context of CT images, similar methods may be applied in the context of other imaging devices, and images to which these methods may be applied may be acquired in a wide variety of ways.

In an imaging device in accordance with embodiments of the present disclosure, the CT scanning unit may be adapted for performing multiple axial scans and/or a helical scan of an object in order to generate the CT projection data. In an imaging device in accordance with embodiments of the present disclosure, the CT scanning unit may comprise an energy-resolving photon counting image detector. The CT scanning unit may include a radiation source that emits radiation for traversing the object when acquiring the projection data.

For example, the CT scanning unit, e.g. the computed tomography (CT) scanner, may include a stationary gantry 202 and a rotating gantry 204, which may be rotatably supported by the stationary gantry 202. The rotating gantry 204 may rotate, about a longitudinal axis, around an examination region 206 for the object when acquiring the projection data. The CT scanning unit may include a support, such as a couch, to support the patient in the examination region 206.

The CT scanning unit may include a radiation source 208, such as an X-ray tube, which may be supported by and configured to rotate with the rotating gantry 204. The radiation source may include an anode and a cathode. A source voltage applied across the anode and the cathode may accelerate electrons from the cathode to the anode. The electron flow may provide a current flow from the cathode to the anode, such as to produce radiation for traversing the examination region 206.

The CT scanning unit may comprise a detector 210. This detector may subtend an angular arc opposite the examination region 206 relative to the radiation source 208. The detector may include a one or two dimensional array of pixels, such as direct conversion detector pixels. The detector may be adapted for detecting radiation traversing the examination region and for generating a signal indicative of an energy thereof.

The imaging device 200 may further include generators 211 and 213. The generator 211 may generate tomographic projection data 209 based on the signal from the detector 210. The generator 213 may receive the tomographic projection data 209 and generate an initial image 311 of the object based on the tomographic projection data 209. The initial image 311 may be input to the input 115 of the processing device 100.

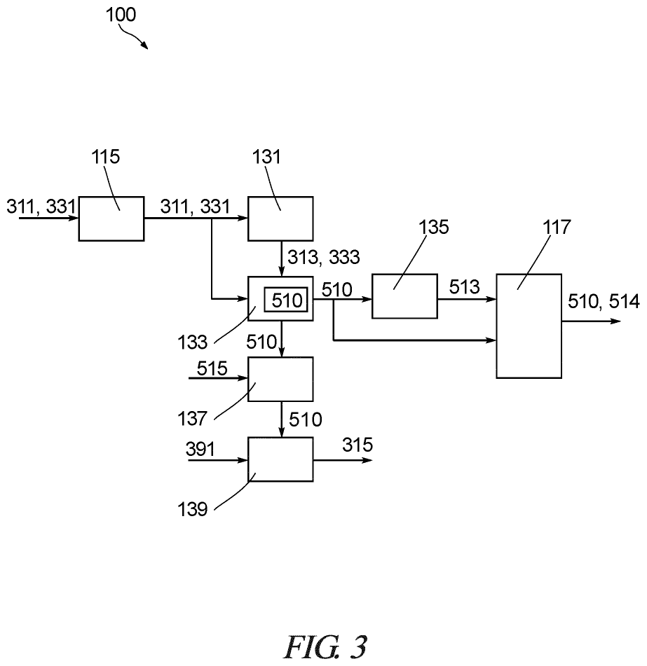

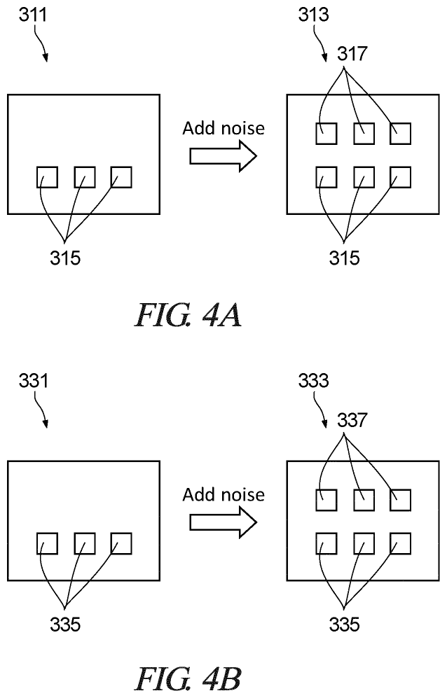

FIG. 3 is a schematic diagram of a processing device 100 according to one embodiment of the present disclosure. FIGS. 4A and 4B show the addition of simulated noise 317, 337 to images 311, 331 to be used for training the neural network model 510 using the processing device 100 of FIG. 3.

As shown in FIG. 3, the processing device 100 may include a plurality of function blocks 131, 133, 135, 137, and 139.

With reference to FIG. 3, the initial image 311 of the object may be provided to the block 131, for example via the input 115. As shown in FIG. 4A, the initial image 311 may contain natural noise 315. With reference to FIGS. 3 and 4A, the block 131 may add simulated noise 317 to the initial image 311 of the object to generate a noisy image 313. The simulated noise 317 may take the same form as the natural noise 315 in the initial image 311.

In some embodiments, with reference to FIGS. 3 and 4B, a plurality of additional initial images 331 of objects may be provided to the block 131. Each of the additional initial image 331 may contain natural noise 335. The block 131 may further add simulated noise 337 to each of the additional initial images 331 to form a plurality of additional noisy images 333. The simulated noise 337 may take the same form as natural noise 335 in each of the plurality of additional initial images 331. In some embodiments, the form of the natural noise 335 in at least one of the additional initial images 331 may be different than the form of the natural noise 315 in the initial image 311.

When referencing simulated noise taking the same form as natural noise, the form relates to a statistical or mathematical model of the noise. As such, simulated noise may be created such that it is mathematically indistinguishable from natural noise occurring in the corresponding initial images.

In some embodiments, the simulated noise 317 may attempt to emulate the outcome of a different imaging process than the process that actually generated the corresponding initial image 311. As such, if the initial image 311 is taken under standard conditions, with a standard radiation dose (i.e., 100% dose), the simulated noise 317 may be added so as to emulate an image of the same content taken with, for example, half of a standard radiation dose (i.e., 50% dose). As such a noise simulation tool may add noise to simulate an alternative imaging process along several such variables.

As shown in FIG. 3, the block 133 may train a neural network model 510 on the noisy image 313 using the initial image 311 as ground truth. In some embodiments, the block 133 may train the neural network model 510 on each of the additional noisy images 333 using the corresponding additional initial images 331 as ground truth for those training iterations.

In the neural network model 510, a tuning variable is extracted or generated. The tuning variable may be a scaling factor that determines how much noise identified by the neural network model 510 is to be removed. The block 135 may receive the trained neural network model 510. The block 135 may identify or receive a first value 513 for the tuning variable that minimizes a training cost function for the initial image 311.

The tuning variable may be given in the model implicitly. For example, in some embodiments, final values in the final layers of the network may be multiplied by some weights and then summed. The tuning variable may then be a component of these weights. The derivation of such a tuning variable is discussed in more detail below. In some embodiments, the tuning variable may be a scalar factor applied to all weights inside the network. In other embodiments, the tuning variable may itself be an array of factors. This may be, for example, in cases where the neural network model, or multiple combined neural network models, predicts multiple uncorrelated components.

By isolating the tuning variable, the neural network model 510 may be able to separately determine which elements in a noisy image 313 are noise 315, 317, and determine how much noise, taking the form of those elements, is to be removed, by selecting an appropriate value for the tuning variable. However, because the noise 315 in the initial image 311 takes the same form as noise 317 simulated in the noisy image 313, the neural network model 510 cannot distinguish between the two types of noise.

Accordingly, because the simulated noise 317 is highly realistic, the network model 510 cannot learn any mechanism to distinguish this simulated noise from the noise 315 in the ground truth image 311, but can only use very simple ways to get a favorable outcome with its predictions to satisfy the training cost function. The network 510 then scales its noise predictions using the tuning variable to achieve ideal results.

The “correct” prediction of the tuning variable, driven by the cost function, will bring down the final noise level, but removing too much noise will also remove parts of the noise 315 that belong to the ground truth images 311, and this will therefore be discouraged by the cost function. Accordingly, by applying the first value 513 of the tuning variable, generated by minimizing the cost function, enough noise 315, 317 is identified and/or removed such that an equilibrium between simulated noise removal and ground-truth noise removal is achieved.

As such, the use of the first value 513 for the tuning variable results in a noisy output image. The block 137 may then assign a second value 515 for the tuning variable. The second value 515 may be different than the first value 513, and the neural network model 510 may identify more noise in the noisy image 313 when using the second value 515 than when using the first value 513. As such, after the neural network model 510 identifies noise 315, 317 in the image taking a recognized form, more noise is removed using the second value 515 than with the first value 513, such that a resulting denoised image 315 is cleaner than the initial image 311.

In one embodiment, the output 117 may provide the trained neural network model 510 to the user and provide a range 514 of potential second values for the tuning variable to the user. As such, the user may select an optimal second value 515 for the tuning variable.

Further, as noted above, distinct ground truth images 311, 331 may have noise 315, 335 that take different forms from each other. As such, when noise 317, 337 is simulated and added to the images, the form or mode taken by the simulated noise matches the noise 315, 335 in the ground truth images. This allows the neural network model, once trained, to detect distinct modes of noise. In some embodiments, distinct tuning variables may be applied to different modes of noise drawn from distinct training images 311, 331.

The block 139 may apply the trained neural network model 510 with the second value 515 to an image 391 to be denoised. The image 391 to be denoised may include images such as the initial image 311, the noisy image 313, and a secondary image that is other than the initial image 311 and the noisy image 313. For example, the image 391 to be denoised may be a new clinically acquired image to be denoised.

The block 139 may configure the neural network model 510 to denoise the image 391. In some embodiments, the block 139 may configure the neural network model 510 to predict noise in the noisy image 313 and to remove the predicted noise from the noisy image 313 to generate the clean or denoised image 315. Typically, if the neural network model 510 is effective, the use of the second value 515 applied to the noisy image 313 should result in a denoised image 315 cleaner than the initial image 311.

In another embodiment, in addition to the neural network model 510, a filter may be used to further shape the predicted noise. This can be helpful if the simulated noise had a slightly different noise power spectrum during the training, which would encourage the neural network model 510 to change its prediction towards the simulated noise.

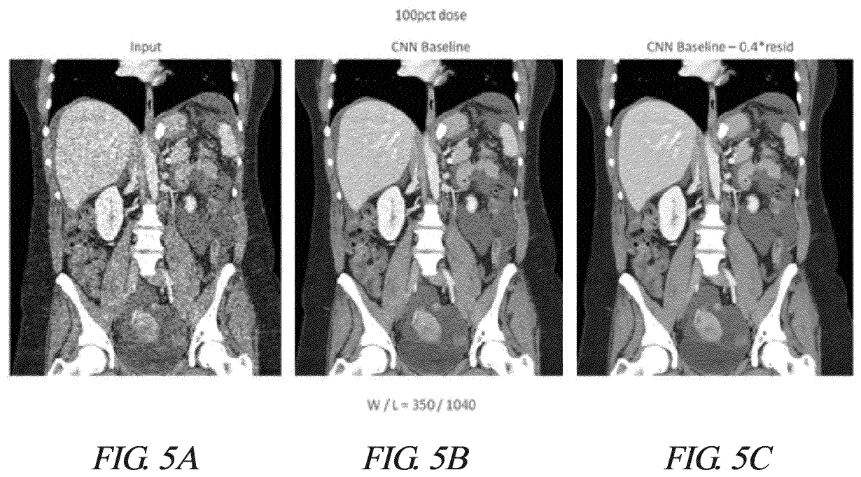

FIGS. 5A-5C illustrate sample results for denoising according to one embodiment of the present disclosure.

FIG. 5A shows a noisy image 391 that the methods described below may be applied to in order to implement the neural network model 510 described herein. The noisy image 391 is then input to a system applying the denoising convolutional neural network (CNN) 510 trained using the method discussed herein. When such a noisy image 391 is denoised using the first value 513 for the tuning variable, as discussed above, the output is very similar to the level of noise present in the initial images 311, 331 discussed above, which include a baseline of noise. In the image of FIG. 5B, the predicted noise was subtracted from the input using the first value 513 for the tuning variable, which yields a CNN baseline result.

FIG. 5C shows an example of a denoised image using the second value 515 for the tuning variable. In the image of FIG. 5C, more of the residuum was subtracted, resulting in an “over-corrected” image with almost no noise.

The ideal value for the tuning variable can be predicted mathematically for certain loss functions. In one example, during training of the neural network model 510, the method attempts to minimize the following value for a given sample, with the sample being a 3D patch of an image:

(n_{ij,sim}−f(μ_{j,real}+n_{j,real}+n_{ij,sim}))²

In this context, μ_{j,real} is the j-th real, noise free patch of an image, n_{j,real} is the real noise that existed on the j-th patch, which is therefore part of the ground truth, and n_{ij,sim} is the i-th noise that was simulated on the j-th patch, which is the assumed true “residuum” for that patch, where the function designed as f (.) is the neural network described herein.

Assuming the network does a good job, the network, i.e., f(μ_{j,real}+n_{j,real} +n_{ij,sim}) approximates our true “residuum,” and generates an estimate [symbol] . However, if the simulated noise was well simulated, the neural network model 510 cannot distinguish the real and simulated noise, such that f(μ_{j,real}+n_{j,sim}+n_{ij,sim})= [symbol] =\hat{n}_{j,real}+\hat{n}_{ij,sim}.

In view of this, the result of applying the network to a sample should be:

(n_{ij,sim}−\hat{n}_{j,real}−\hat{n}_{ij,sim})²

As discussed above, the neural network model 510 can learn to scale its output using a learnable factor β. This scaling factor can be moved outside of the network. Further, real and simulated noise and estimates are not correlated, and we can assume that they have zero mean.

We can therefore get:

(n_{ij,sim}−β\hat{n}_{j,real}−β\hat{n}_{ij,sim})²=((n_{ij,sim}−β\hat{n}_{ij,sim})−β\hat{n}_{j,real})²

This approximately equals:

(n_{ij,sim}−β\hat{n}_{ij,sim})²−(β\hat{n}_{j,real})²

Based on this model, and as discussed above, the network will inherently learn a suitable value for the learnable factor β which will minimize the cost terms of the function. Therefore, the best value of the learnable factor β for use in the model will not lead to a complete removal of the noise later, because that is not the value for β that would minimize the cost function part being related to only the simulated noise, which is used for the training. The noise predicted by the network based on an input image is instead scaled by a factor β<1.0.

Based on this, if a first value for the tuning variable λ, which would be 1.0 for this particular cost function, removes the residuum imperfectly, and the final output of our denoising is output=input−λ* residuum, we would then assign a second value for the tuning variable λ such that λ>=1.0.

If we assume that no further denoising is applied to the raw data before reconstruction, we can estimate the value for β for a given training scenario:

(n_{ij,sim}−β\hat{n}_{ij,sim})²+(β\hat{n}_{j,real})²≈(1−β)²VAR(\hat{n}_{ij,sim})+β²VAR(\hat{n}_{j,real})

We can then tailor this to a dose fraction α, i.e., the factor that is used to simulate a lower dose level than the original one in order to get more noise in a CT image used during training, in which case:

$$VAR ( {\hat{n}}_{ij , sim} ) + VAR ( {\hat{n}}_{j , real} ) = \frac{1}{α} VAR ( {\hat{n}}_{j , real} ) \geq VAR ( {\hat{n}}_{ij , sim} ) = ( \frac{1}{α} - 1 ) VAR ( {\hat{n}}_{j , r e a l} )$$

Thus, the cost function that is minimized is:

$${( {n}_{ij , sim} - β {\hat{n}}_{j , r e a l} - β {\hat{n}}_{ij , sim} )}^{2} \approx {( 1 - β )}^{2} ( \frac{1}{α} - 1 ) VAR ( {\hat{n}}_{j , r e a l} ) + {β}^{2} VAR ( {\hat{n}}_{j , r e a l} )$$

In this way, the learnable factor β is minimized for 1−α, where α is the dose factor used for training. The optimal tuning variable λ that is used to increase the subtraction of predicted noise is then calculated by

$$λ = \frac{1}{β} = \frac{1}{1 - α} ,$$

which compensates for the learned factor β in a multiplicative fashion. As such, if α is 0.5, the optimum value for the tuning variable

$$\frac{1}{β}$$

is 2, and if α is 0.25, the optimum value for

$$\frac{1}{β}$$

is 1.33.

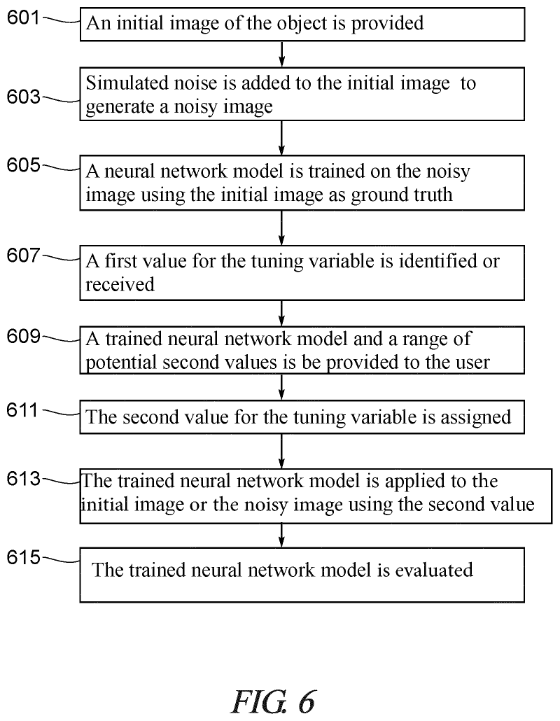

FIG. 6 is a flowchart of a method according to one embodiment of the present disclosure.

In an exemplary method according to one embodiment, in 601 of FIG. 6, the initial image 311 of the object may be provided to the processing device 100. The initial image 311 typically has at least some natural noise 315. Then, in 603 of FIG. 6, simulated noise 317 may be added to the initial image 311 of the object to generate a noisy image 313. The simulated noise 317 typically takes the same form, or a similar form, as the natural noise 315 already present in the initial image.

Then, after adding the simulated noise 317, in 605 of FIG. 6, the neural network model 510 may be trained on the noisy image 313 using the initial image 311 as ground truth. The cost function used to optimize the neural network model 510 generated using the neural network typically includes a tuning variable that can be used to minimize the function value during training. Then, in 607 of FIG. 6, a first value 513 for the tuning variable in the neural network model 510 may be identified or received. The first value 513 is the value that minimizes the cost function and is therefore automatically generated by the training process.

Typically, the first part of the method, which trains the neural network model 510, may be repeated many times. Accordingly, steps 601-605 may be repeated many times with different initial images. Over time, as the training method attempts to minimize a cost function, the first value 513 may be identified in 607. It is noted that the method may continue to repeat steps 601-605 as additional training images are made available, thereby improving and refining the selected value for the first value 513.

After identifying the first value 513 for the tuning variable, a second value 515 may be sought in order to tune the model and improve the output of the neural network model 510. In some embodiments, the second value 515 may be identified by the neural network model 510 during training. In other embodiments, such as that shown in FIG. 6, the, the trained neural network model 510 may identify a range of potential second values to be provided to the user or a system implementing the model, at 609.

Then, in 611 of FIG. 6, the second value 515 for the tuning variable may be assigned. This may be after being selected by the network model 510 itself, or after selection by the user. Typically, the second value 515, or the range from which the second value is drawn, is selected such that the neural network model 510 identifies more noise in the image when applying the second value 515 than when applying the first value 513. In this way, the use of the second value 515 to identify noise to be removed from the image results in the removal of more noise than the use of the first value 513 would.

In one embodiment, in 613 of FIG. 6, the trained neural network model 510 may be applied to the noisy image 313 of the object using the second value 515 for the tuned tuning variable to predict noise in the noisy image 313 being evaluated. This may allow for the evaluation of the effectiveness of the neural network model 510 in comparison with the ground truth image 311 originally provided. In another embodiment, in 613 of FIG. 6, the trained neural network model 510 may be applied to the initial image 311 of the object using the second value 515 for the tuned tuning variable to predict noise in the initial image 311 in order to evaluate the efficacy of the neural network model 510 in the originally provided image.

In some embodiments, the second value 515 may be selected formulaically, or from a range determined formulaically, as discussed above. The basis for such selection may include, for example, a dose factor used to simulate the additional noise that is added to the training data.

Then, in 615 of FIG. 6, the trained neural network model 510 is evaluated based on the resulting images, i.e. a clean or denoised image 315. In one example, the generation of the image 315 may be conducted, for example, by generating an image of noise in the initial image 311 and subtracting the image of noise from the noisy image 313.

The method of FIG. 6 shows one iteration of training a neural network model 510 in steps 601-605. As discussed above, these first few steps may be repeated many times, followed by a tuning process shown in the method. As such, it will be understood that many such iterations are performed, each including a paired ground truth image 311, 331 and a corresponding noisy image 313, 333 in which simulated noise has been added. In each of those images, the noise 317, 337 simulated in the noisy image may be simulated such that it takes the same form as the noise 315, 335 in the corresponding ground truth image. In this way, the neural network model 510 may be trained in a way that it cannot distinguish between noise 315, 335 in the ground truth image 311, 331, and the corresponding simulated noise 317, 337 in the corresponding noisy image 313, 333.

In some embodiments, the forms taken by the noise 315, 335 in the ground truth images 311, 331 may be deliberately selected to be distinct from each other, such that the neural network model 510 may be trained to identify a variety of potential modes of noise common in medical imaging.

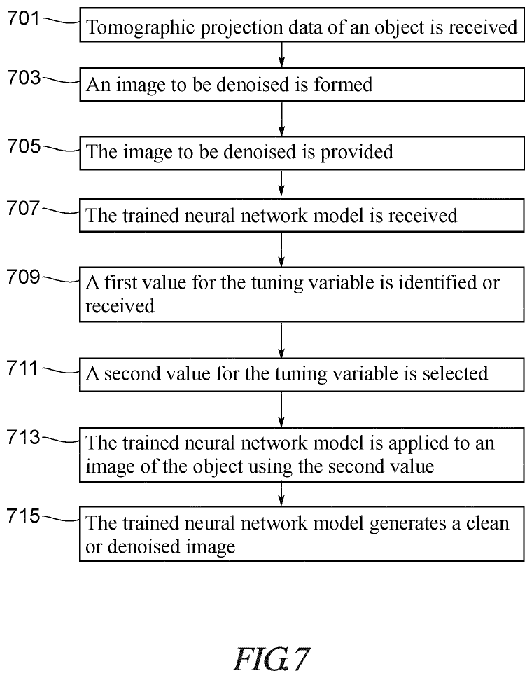

FIG. 7 is a flowchart of a method for denoising an image according to another embodiment of the present disclosure.

In an exemplary method according to one embodiment, in 701 of FIG. 7, tomographic projection data 209 of the object may be received using a radiation source 208 and a radiation sensitive detector 210 that detects radiation emitted by the source 208. The tomographic projection data 209 is used to form an image 391 to be denoised using a trained neural network at 703. Then, in 705, the image 391 to be denoised may be provided to the processing device 100.

In 707, a trained neural network model 510 configured to predict noise in an image of an object is received, such as the network model discussed above. In 709, a first value 513 for the tuning variable in the neural network model 510 may identified or received. The first value 513 of the tuning variable is a value for the tuning variable used during training of the network model in order to minimize a training cost function. It will be understood that the identification of a first value 513 may be by providing such a value to a system implementing the denoising method, or it may be by simply providing a network model in which a first value 513 exists, and was determined during training, and in which a second value 515 to be applied during use of the neural network model 510 differs from the first value in the ways described.

Accordingly, in 711, a second value 515 for the tuning variable different than the first value 513 may be selected. This second value 515 is different than the first value 513 which minimized the cost function of the neural network model 510 during training, and is selected such that more noise is identified or predicted in the noisy image by using the second value 515 than would be predicted by using the first value 513.

Then, in 713 of FIG. 7, the trained neural network model 510 is applied to the image 391 of the object using the second value 515 for the tuned tuning variable for denoising the image 391. Then, in 715 of FIG. 7, the trained neural network model 510 may generate a clean or denoised image 315, which may be output to the user. The generation of a clean image may be by generating a map of predicted noise in the noisy image 391 and then subtracting the noise from the image, or, alternatively, by directly removing identified noise from the image.

In some embodiments, an actual second value 515 for the tuning variable is provided to a user along with the neural network model 510 such that the second value is an idealized value for the model. In other embodiments, a range of potential second values 515 may be provided such that a user, or a system implementing the model, may select an idealized second value for a particular image 391 or scenario being analyzed.

It will be understood that although the methods described herein are described in the context of CT scan images, various imaging technology, including various medical imaging technologies are contemplated, and images generated using a wide variety of imaging technologies can be effectively denoised using the methods described herein.

The methods according to the present disclosure may be implemented on a computer as a computer implemented method, or in dedicated hardware, or in a combination of both. Executable code for a method according to the present disclosure may be stored on a computer program product. Examples of computer program products include memory devices, optical storage devices, integrated circuits, servers, online software, etc. Preferably, the computer program product may include non-transitory program code stored on a computer readable medium for performing a method according to the present disclosure when said program product is executed on a computer. In an embodiment, the computer program may include computer program code adapted to perform all the steps of a method according to the present disclosure when the computer program is run on a computer. The computer program may be embodied on a computer readable medium.

While the present disclosure has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the disclosure.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

1. A method for training and tuning a neural network model, comprising:
providing an initial image of an object, the initial image containing natural noise;
adding simulated noise to the initial image of the object to generate a noisy image, the simulated noise taking the same form as the natural noise in the initial image;
training a neural network model on the noisy image using the initial image as ground truth, wherein in the neural network model a tuning variable is extracted or generated, the tuning variable defining an amount of noise removed during use;
identifying a first value for the tuning variable that minimizes a training cost function for the initial image; and
assigning a second value for the tuning variable, the second value different than the first value, wherein the neural network model identifies more noise in the noisy image when using the second value than when using the first value.

2. The method of claim 1, further comprising providing a plurality of additional initial images of objects, adding the simulated noise to each of the initial images to form a plurality of additional noisy images, wherein the simulated noise takes the same form as the natural noise in each of the plurality of additional initial images, and training the neural network model on each of the additional noisy images using the corresponding initial images as ground truth.

3. The method of claim 2, wherein the form of the natural noise in at least one of the additional initial images is different than the form of the natural noise in the initial image.

4. The method of claim 1, further comprising applying the trained neural network model with the second value for the tuning variable to a secondary image to be denoised.

5. The method of claim 1, further comprising providing the trained neural network model to a user and providing a range of potential second values for the tuning variable.

6. The method of claim 1, wherein the neural network model generates an image of noise in the initial image and subtracts the image of noise from the noisy image to generate a clean image.

7. The method of claim 1, wherein the tuning variable is a scaling factor that determines how much noise identified by the neural network model is to be removed.

8. A denoising method, comprising:
training and tuning a neural network model comprising:
providing an initial image of an object, the initial image containing natural noise;
adding simulated noise to the initial image of the object to generate a noisy image, the simulated noise taking the same form as the natural noise in the initial image;
training a neural network model on the noisy image using the initial image as ground truth, wherein in the neural network model a tuning variable is extracted or generated, the tuning variable defining an amount of noise removed during use;
identifying a first value for the tuning variable that minimizes a training cost function for the initial image; and
assigning a second value for the tuning variable, the second value different than the first value, wherein the neural network model identifies more noise in the noisy image when using the second value than when using the first value;
applying the trained neural network model to the noisy image of the object using the second value for the tuning variable to predict noise in the noisy image; and
removing the predicted noise from the noisy image to generate a denoised image.

9. The method of claim 8, further comprising outputting the denoised image to a user.

10. The method of claim 8, further comprising:
receiving tomographic projection data of an object using a radiation source and a radiation sensitive detector to detect radiation emitted by the radiation source; and
generating an image of the object to be denoised based on the tomographic projection data.

11. A denoising system, comprising:
a memory that stores a plurality of instructions;
processor circuitry that couples to the memory and is configured to execute the instructions to:
provide an initial image of an object, the initial image containing natural noise;
add simulated noise to the initial image of the object to generate a noisy image, the simulated noise taking the same form as the natural noise in the initial image;
train a neural network model on the noisy image using the initial image as ground truth, wherein in the neural network model a tuning variable is extracted or generated, the tuning variable defining an amount of noise removed during use;
identify a first value for the tuning variable that minimizes a training cost function for the initial image;
assign a second value for the tuning variable, the second value being different than the first value, wherein the neural network model identifies more noise in the noisy image when using the second value than when using the first value;
apply the trained neural network model to the noisy image of the object using the second value for the tuning variable to predict noise in the noisy image; and
remove the predicted noise from the noisy image to generate a denoised image.

12. The system of claim 11, wherein the processor circuitry is further configured to:
provide a plurality of additional initial images of objects;
add the simulated noise to each of the initial images to form a plurality of additional noisy images, wherein the simulated noise takes the same form as the natural noise in each of the plurality of additional initial images, and
train the neural network model on each of the additional noisy images using the corresponding initial images as ground truth.

13. The system of claim 12, wherein the form of the natural noise in at least one of the additional initial images is different than the form of the natural noise in the initial image.

14. (canceled)

15. The system of claim 11, further comprising an imaging device configured to:
receive tomographic projection data of an object using a radiation source and a radiation sensitive detector to detect radiation emitted by the source; and
generate an initial image of the object based on the tomographic projection data.

16. The method of claim 8, wherein the neural network model generates an image of noise in the initial image and subtracts the image of noise from the noisy image to generate a clean image.

17. The method of claim 8, wherein the tuning variable is a scaling factor that determines how much noise identified by the neural network model is to be removed.
